(19) United States
(12) Patent Application Publication
(10) Pub. No.: US 2002/0065034 A1
(43) Pub. Date: May 30, 2002

(54) Methods and system for universal interactive services for broadcasting media

(76) Inventor: Jack Zhang, Ijamsville, MD (US)

Correspondence Address: GREENBERG-TRAURIG, 1750 TYSONS BOULEVARD, 12TH FLOOR, MCLEAN, VA, 22102, US

(21) Appl. No.: 09/725,761

(22) Filed: Nov. 30, 2000

Related U.S. Application Data
(60) Provisional application No. 60/168,070, filed on Nov. 30, 1999.
(60) Provisional application No. 60/174,588, filed on Jan. 5, 2000.
(60) Provisional application No. 60/177,623, filed on Jan. 24, 2000.
(60) Provisional application No. 60/185,394, filed on Feb. 28, 2000.
(60) Provisional application No. 60/187,514, filed on Mar. 7, 2000.
(60) Provisional application No. 60/215,920, filed on Jul. 3, 2000.
(60) Provisional application No. 60/229,957, filed on Sep. 1, 2000.

(51) Int. Cl. H04H 9/00; H04N 7/16; H04N 7/173

(52) U.S. Cl. 455/2.01; 725/9; 725/24

(57) ABSTRACT

A Universal Interactive Service system which allows sponsors of electronic media advertising (such as radio, television advertising) to interact with its audience in real time that are exposed to their advertising and to facilitate the purchasing and selection of electronic media advertising by advertising buyers, such as advertisers and ad agencies. This is accomplished through a number of methods and devices, which include a Universal Interactive Service (UIS) that is used with the Internet and a wireless service provider. An improved method of multiphase prioritized user registration technique (M-PURT) for easier user registration and meaningful sentence query logic (MSQL) for a buyer to search for advertising defined by a specific search criteria are also included as part of these systems and methods.

This application claims the benefit of U.S. Provisional Patent Application No. 60/168,070 filed Nov. 30, 1999; U.S. Provisional Patent Application No. 60/174,588 filed Jan. 05, 2000; U.S. Provisional Patent Application No. 60/177,623 filed Jan. 24, 2000; U.S. Provisional Patent Application No. 60/185,394 filed Feb. 28, 2000; U.S. Provisional Patent Application No. 60/187,514 filed Mar. 7, 2000; U.S. Provisional Patent Application No. 60/215,920 filed Jul. 3, 2000; and, U.S. Provisional Patent Application entitled “Method and System for Instant Opt-In and Permission Truly-Given (iOPT) Advertising Services,” filed Sep. 1, 2000, the entire disclosures of which are incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

1. Field of the Invention

The present invention relates generally to an interactive electronic media advertising application service system. More specifically, the invention provides a universal system platform for media consumers, i.e. radio listeners, TV viewers, etc., to instantly and easily interact with electronic media to find specific information, express opinion or asks a question; allows electronic media and sponsors of advertising (such as radio, television advertising) to get more information about listeners that are exposed to their advertising; and makes it easier for advertising buyers, such as advertisers and ad agencies, to purchase and select electronic media advertising.

2. Related Art

In the radio and print media industries, it is a known practice for broadcasters or publishers to broadcast or publish a code which is associated with an advertisement and for persons who desire to receive further information about the advertisement to communicate the code to the broadcaster or publisher in furtherance of identifying the particular information in which the person is interested.

U.S. Pat. Nos. 5,867,780 and 5,752,186 to Malackowski discloses an “information fulfillment” system wherein a consumer observing an advertisement on a billboard or in a radio broadcast is prompted to dial an access number (e.g., *522) on his wireless telephone in order to request more information about products or services in the advertisement. Once the call is connected, the consumer is prompted telephonically to dial or speak a further code specifically identifying the advertisement in which he is interested. The consumer then interfaces with a live operator or automated messaging system, and thereafter receives the additional product or service information either audibly during the call or via mail sent to the consumer's home or business.

U.S. Pat No. 5,579,124 to Aijala et al. discloses a system for encoding and decoding information in a broadcast segment wherein spread spectrum encoding is used to encode into the broadcast signal information identifying a program being broadcast. The broadcast is received and the information is decoded and then collected at a central facility, where it is used to track audience listening habits or to create a log showing which advertisers' segments have actually aired.

U.S. Pat. No. 4,989,233 to Schakowsky et al. outlines how recipients of a promotion broadcast over a one-way mass medium are prompted to respond through their telephone sets. Having different subscriber telephone numbers and the task of handling the resulting mass response is divided into a call receiving phase and a subsequent response completing phase.

U.S. Pat. No. 5,473,673 issued to Van Wijk et al. outlines a system in which subscribers are able to transmit, via the telephone network and a processing system, selection codes to a television or radio station in response to a selection questionnaire presented in a television or radio program using a code transmitter.

U.S. Pat. No. 5,273,437 issued to Caldwell et al., provides a system that allows a speaker to pose a question to an audience and request a response, which the audience can provide by a simple physical output to a device in their possession. This system does not, however, refer to feedback from a radio broadcast or television broadcast, but rather pertains to a speaker making a presentation in front of a large audience.

U.S. Pat. No. 5,640,192 issued to Garfinkle outlines use of an interactive television system in which viewer inputs are correlated in real-time with other viewer inputs with the particularized results made available to each participating viewer. A programmed interactive computer system processes the viewer inputs in accordance with parameters and algorithms correlated with transmitted television program material. The system processes, for each participating viewer, his results based on the algorithm for the broadcast television program and the inputs of the other participating viewers.

U.S. Pat. No. 5,880,721 to Yen outlines radio modulation technology to transmit the data, images and sound from a computer monitor to a larger television screen. Infrared remote control signals are transmitted back to the computer terminal by way of reverse UHF circuit, to facilitate remote control of the computer, so that a user will be able to use a radio infrared-ray keyboard or mouse to operate the computer system.

U.S. Pat. No. 5,905,865 issued to Palmer et al., outlines a method and apparatus for connecting a computer to electronic addresses in sync with an audio or video broadcast. Simultaneously with the broadcasting of audio or video programming, an address transmitter transmits an address, such as a URL, identifying an online service which contains information about the audio or video programming.

Particular advances have occurred in the area of television and radio broadcasting. U.S. Pat. No. 5,708,478 issued to Tognazzini, outlines a computerized system for enabling radio listeners and television viewers to utilize advertising information subsequent to when such information is broadcast. Viewers can gain access to print out or display advertising information and can even contact an advertiser to obtain additional information and to even purchase an advertised product.

### OBJECTS AND SUMMARY OF THE INVENTION

The universal broadcasting interactive service system for electronic media advertising according to the invention provides a universal system platform for media consumers, i.e. radio listeners, TV viewers, etc., to instantly and easily interact with electronic media to find specific information, express opinion or asks a question; allows electronic media and the sponsors of advertising (such as radio, television and computer advertising) to get more information about listeners that are exposed to their advertising; and makes it easier for advertising buyers, such as advertisers and ad agencies, to purchase and select electronic media advertising.

This is accomplished through a number of methods and devices, which include a Universal Interactive Service system (previously named as Web-based radio advertising business application service system, or WRABAS and a closely derived Web-based information system for broadcasting and response applications, or WISBRA) that is used with the Internet and a wireless messaging provider. An improved method of multiphase prioritized user registration technique (M-PURT) for easier user registration and meaningful sentence query logic (MSQL) for a buyer to search for advertising defined by a specific search criteria are also included as part of these systems and methods.

Accordingly, it is a principal object of the invention to provide interactivity to currently non-interactive broadcast media by electronically connecting broadcasting facilities, advertiser and audience, creating a broadcast station and advertiser agnostic interaction environment, and efficiently and cost effectively managing the interactions in real-time.

It is another object of the invention for broadcast facilities to communicate the availability of advertising spots in future broadcasting logs to potential sponsors or buyers, and the content and information related to particular segments on current and past the broadcasting log to the audience in real time through internet, wireless devices and other telecommunication means. Web site.

It is another object of the invention to give potential buyers an efficient method needed to handle the spot buying cycle, including easily selecting and de-selecting spots, as well as entering the contents of a spot and buyer and payment information.

It is a further object of the invention to help listeners find detailed and complete information related to a specific advertisement or to facilitate on-line transactions.

Still another object of the invention is to provide post-broadcasting listener support to provide interested listeners with complete information about an advertisement missed during listening or forgotten after listening to a broadcast.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is the architecture of a Universal Interactive Service (UIS) system for broadcasting electronic media according to the present invention.

FIG. 2 is a flowchart of the Universal Interactive Service (UIS) system for broadcasting media and its typical users.

FIG. 3 is a flowchart of the methods used by radio station programming personnel in the UIS system.

FIG. 4 is a flowchart of the methods used by radio announcers in the US system.

FIG. 5 is a flowchart of the methods used by listeners looking for information in the UIS system.

FIG. 6 is a flowchart of the methods used by advertisers and agencies in the UIS system.

FIG. 6a is an illustration showing how a station log is processed with syndicator log on UIS.

FIG. 6b is an illustration showing how a station log is processed on UIS to link to station generated A-IFI corresponding to syndicator log.

FIG. 6c is an illustration showing how a station log is processed on UIS to link to syndicator generated A-IFI corresponding to syndicator log.

FIG. 7a is an illustration of a conventional user registration method.

FIG. 7b is an illustration of the multiphase prioritized user registration technique (M-PURT).

FIG. 8 is an example of meaningful sentence query logic (MSQL) method.

FIG. 9 is an overview of a Universal Interactive Service Implementation (UIS-I) UIS method.

FIG. 9a is an overview of a second embodiment of a Universal Interactive Service Implementation (UIS-I) method.

FIG. 9b is a flowchart for a program and A-IFI look up process FIG. 10 is an illustration of the electronic media terminal and wireless handheld device used with the UIS-I method.

FIG. 11 is a flowchart of the generation of ad content and UMCID used with the UIS-I method.

FIG. 12 is a flowchart outlining the use of the electronic media terminal according to the present invention.

FIG. 13 is a flowchart outlining the use of the wearable wireless device used with the (UIS-I) method and the wireless messaging provider.

FIG. 14 is a flowchart outlining the use of the UIS-I method and UMCID.

### DETAILED DESCRIPTION

As used herein, “advertising” generally means any information publicized, including but not limited to, news, product or service information, weather, traffic, etc. Advertisers are any party, individual or organization, assembling, gathering, publishing or sponsoring advertising information. Electronic media generally means a collection of information conveyed to the public electronically. For purposes of clarity, the description below uses radio broadcasting to exemplify electronic media; radio stations and syndicators are examples of electronic broadcast facilities and radio listeners examples of electronic media audiences. It is not intended that the scope of the application be limited to one particular medium.

As used herein, the term “C-IFI” generally means consumer generated information (or instructions) for interactivity typically during registration or managing interactive interest. The term “A-IFI” generally means information (or instructions) for interactivity, which are typically provided by the advertisers at the time when the content is prepared for electronic media for broadcasting, such as preferred contact information, coupon offers for specific advertising copy, reminder information before the coupon expires, answers to frequently asked questions.

The term “UIS” is used herein to mean universal interactivity services, and the term “UIS-I” is used to mean universal interactivity service implementation.

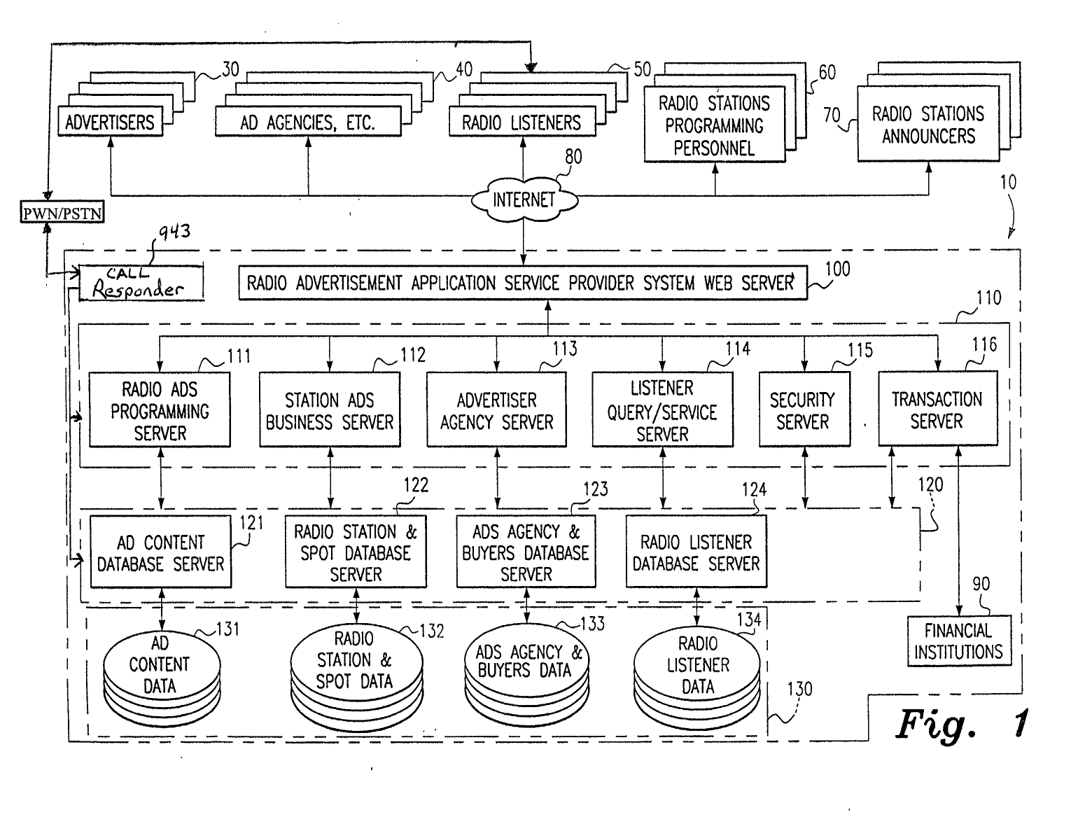

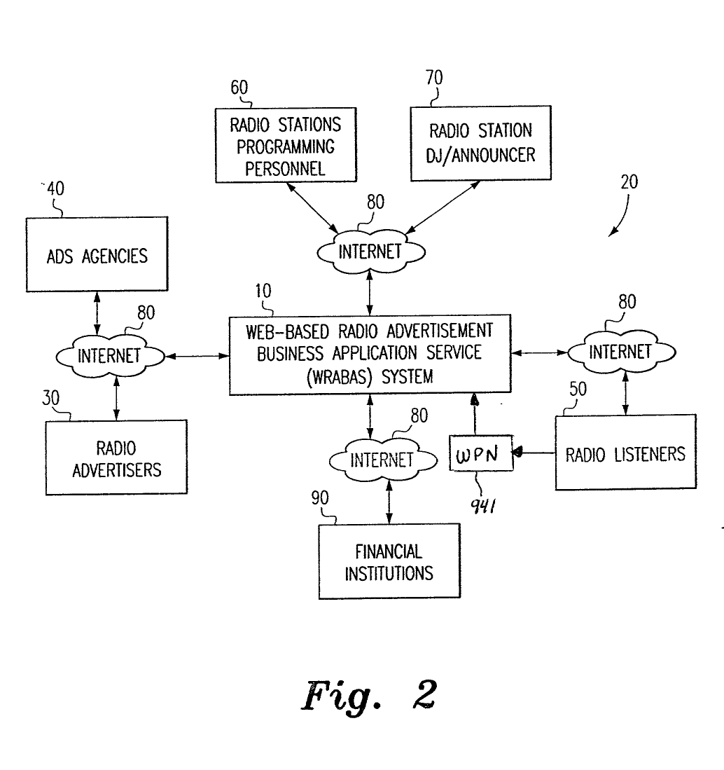

With reference to FIGS. 1 and 2, the present invention relates to a Universal Interactive Service Implementation (UIS-I) system 10 and method 20 that connects computers or other communication devices of advertisers 30, ad agencies 40, radio listeners 50, radio station programming personnel 60 and radio station announcers 70 via the Internet 80, as shown in FIG. 1.

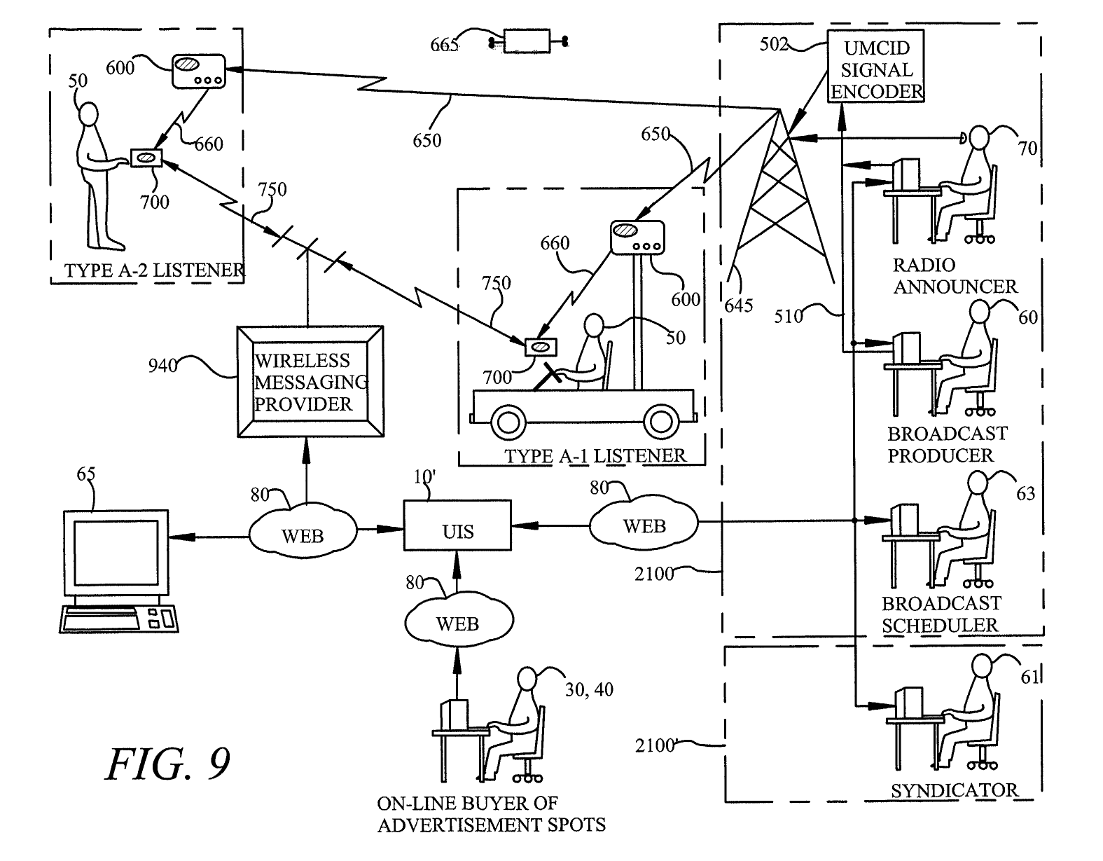

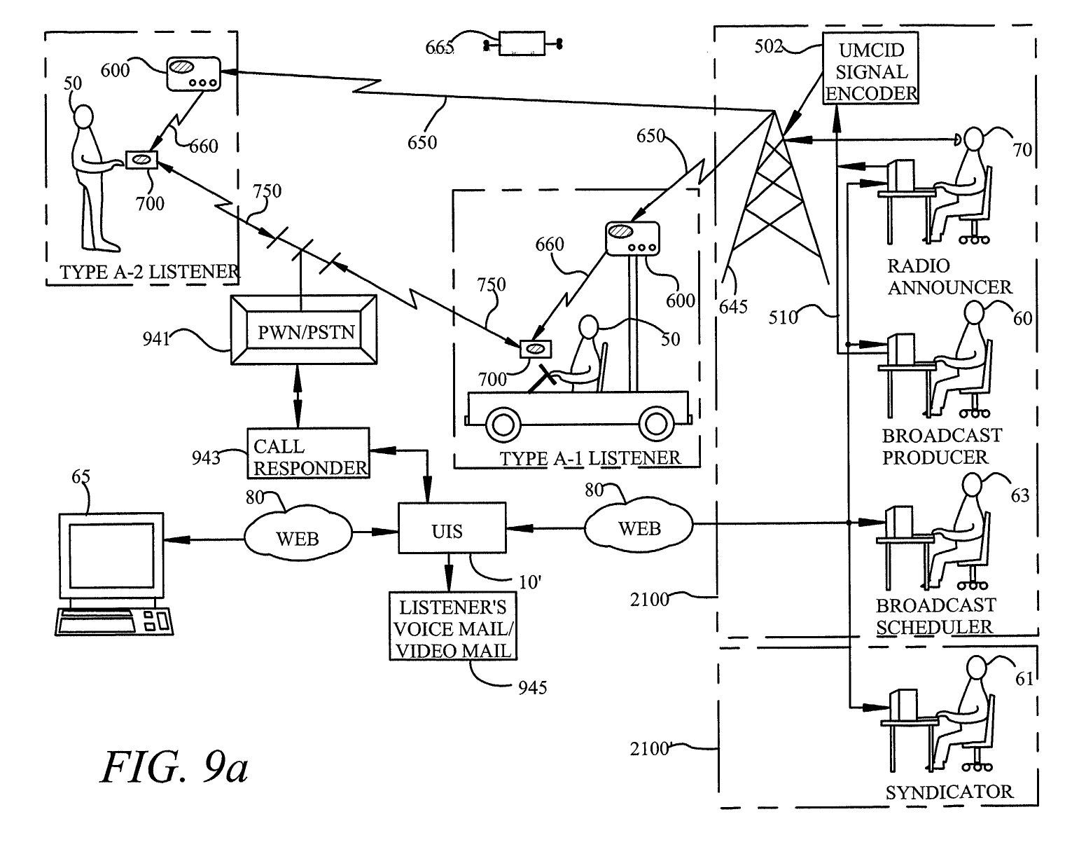

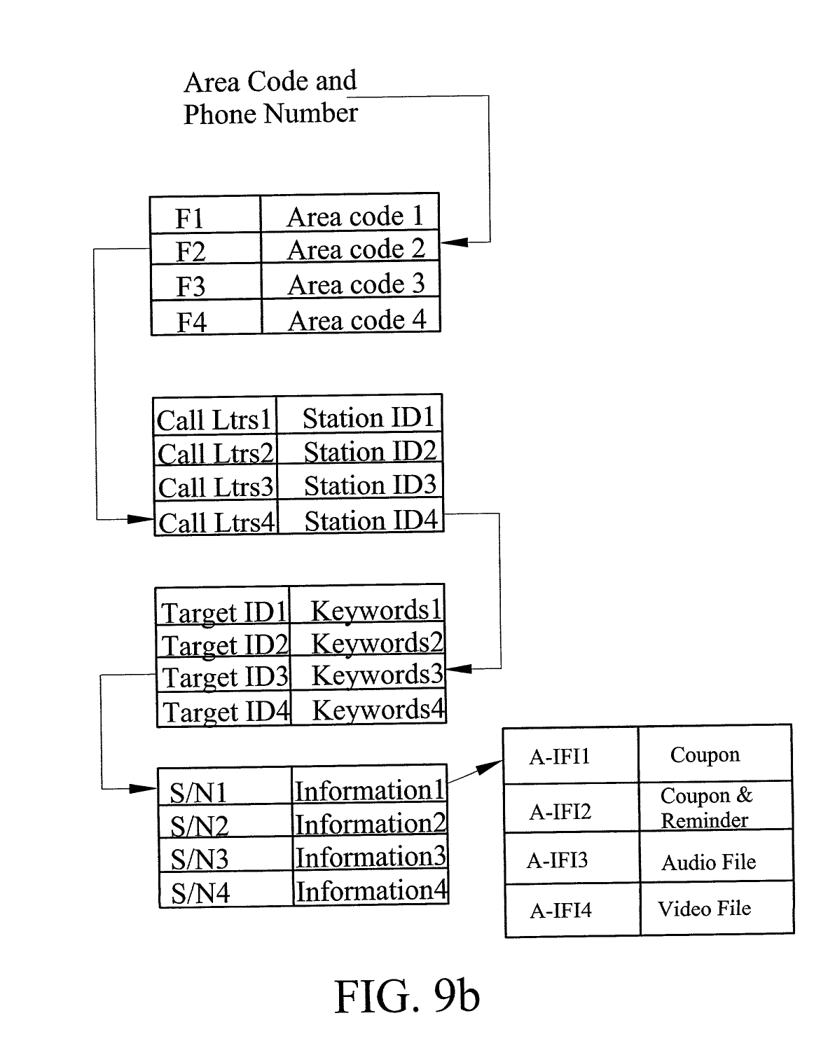

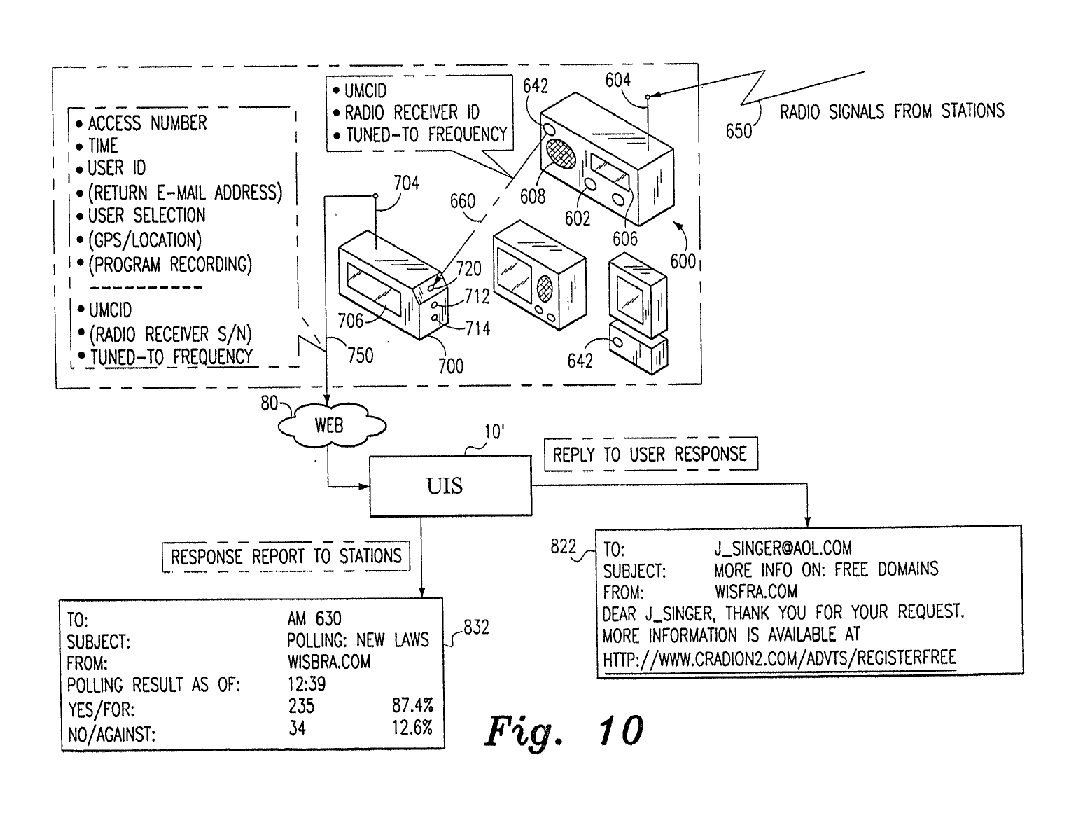

The system 10 preferably comprises a radio advertisement application service provider system Web server layer 100, a business logic server layer 110, a database server layer 120, a data storage layer 130 and an interface layer 943 (as shown in FIG. 9a) to wireless handheld device 700 that is kept by the radio listeners 50.

The business logic server layer 110 consists of a radio ad's programming server 111, a station ads business server 112, an advertising agency server 113, a listener query and service server 114, a security server 115 and a transaction server 116. The database server layer 120 consists of an ad content server 121, a station and spot database server 122, an ads agency and buyer database server 123 and a listener database server 124.

The data storage layer 130 consists of an ad content database 131, a station and spot database 132, an ad agency and buyers database 133 and a listener database 134. The wireless handheld device 700 is capable of requesting information on a radio, television or electronic media broadcast upon actuation of the device 700, with the information being transmitted by the system 10 back to the user, and having the information collected, sampled, compiled and transmitted by the system 10 for further use by other users of the system 10. This is discussed in greater detail in the discussion of FIG. 9.

A Web-based radio, television and electronic media advertising business application service method 20 is also developed for typical users, comprising the steps of having station programming personnel 60, station disc jockeys and announcers 70, listeners 50 and ad agencies 40 and advertisers 30 each individually accessing the system 10.

Since the system 10 is an Internet 80 based complete business application system using conventional Internet browser interfaces that are familiar to most computer users, the system 10 can work with any existing computer systems with Internet 80 access without any hardware or software change. The typical users will log-on the Internet 80 via connection to an Internet Service Provider (ISP). For the user of the wireless device 700, the connection can be through dial-up using speech to interact with UIS system or wireless text messaging. The system 10 Web site is also designed to allow the simultaneous use of the system 10 by all types of users.

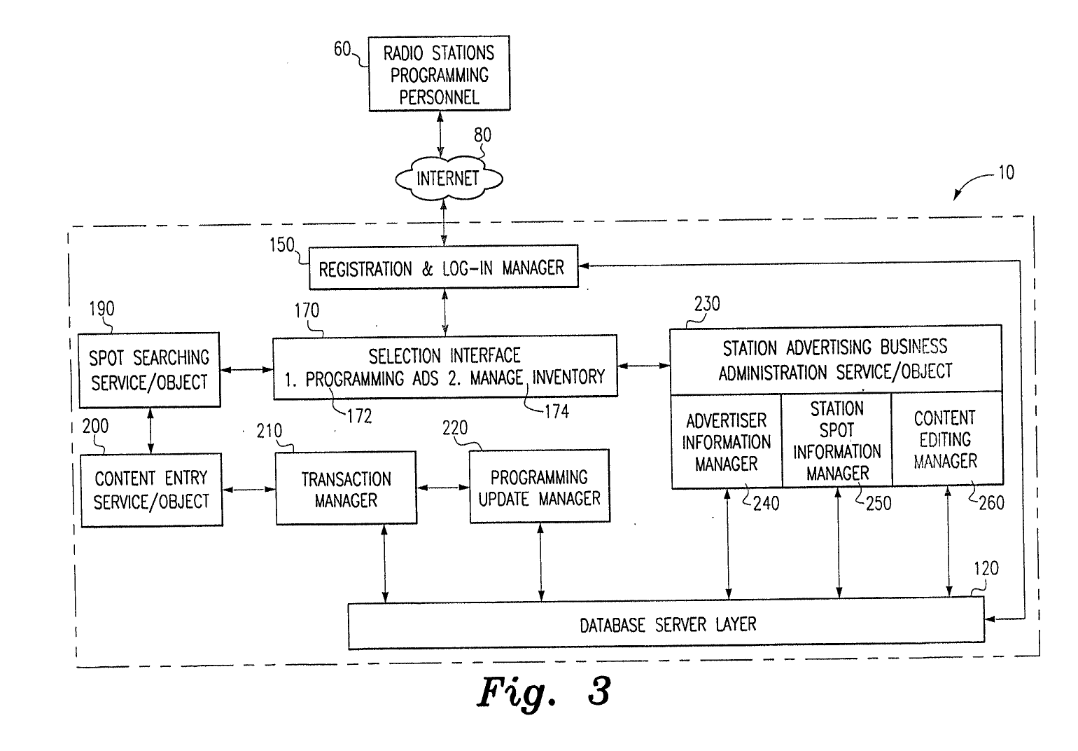

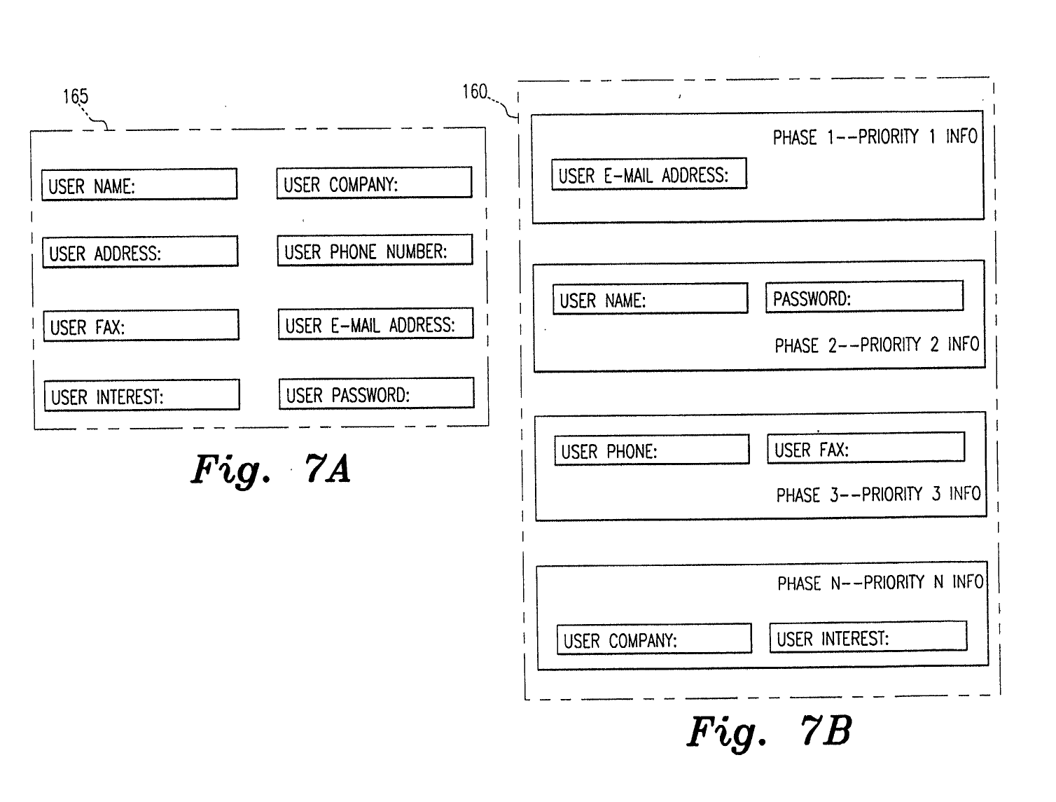

As shown in FIG. 3, the station programming personnel 60 register and log into 150 the system 10. Like all typical users, station programming personnel 60 use a multiphase prioritized user registration technique (M-PURT) 160 that is described in greater detail in the discussion of FIG. 7. Once registered, the station programming personnel 60 goes to the selection interface 170, where they may choose, for example, between programming ads 172 or managing inventory 174.

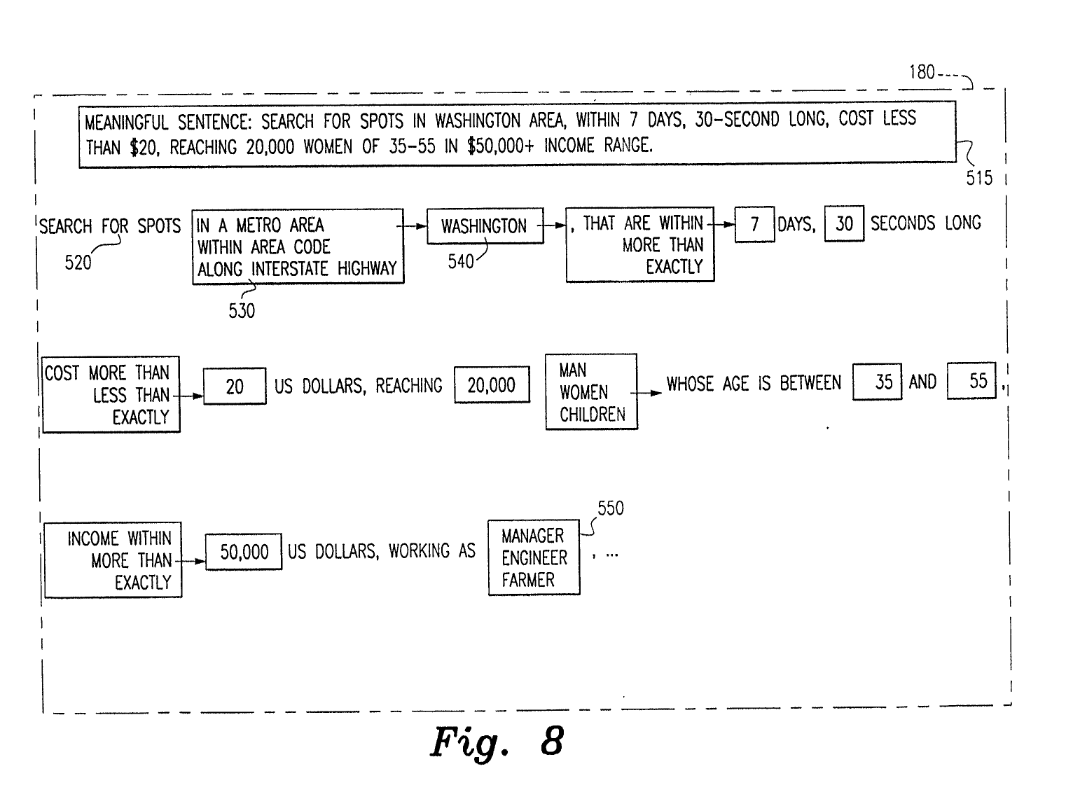

Assuming that programming ads 172 is chosen, the station programming personnel 60, through the meaningful sentence query interface (MSQI) 180, can go into the spot searching function 190 to find airtime spots within a certain criteria. This function will help the buyer find highly targeted airtime spots quickly and easily. Further information concerning the MSQI 180 is outlined in the discussion of FIG. 8.

Once the spot searching function 190 is completed, the station programming personnel 60 can access the interface of the content entry function 200 to enter the message content or content requirement for ad production. The same interface will also ask to input A-IFI (Instruction or information for Interactivity) such as preferred contact information, coupon offers for specific advertising copy, reminder information before the coupon expires, answers to frequently asked questions among other information to be used during interactions between an interested listeners, advertiser and the radio station. Once the content is entered, the system 10 will process the entry, store the content and give a recommended spot length to use to air the ad content.

When the station programming personnel 60 chooses to complete the transaction, the transaction function 210 will display an interface to collect payment information and conduct user profile confirmation and changes. When the transaction is completed, the system 10 will perform updates through the programming update function 220. The programming update function 220 will publish the latest schedule for all stations affect by the transaction just completed and send the schedule to the affected station. This is accomplished using push technology and publish-subscribe programming techniques for example. The programming update function 220 will also update the entire database server layer 120 of the system 10.

Assuming now that manage inventory 174 is chosen, the station programming personnel 60 can access the station advertising business administration function 230, which consists of the advertiser information function 240, the station spot information function 250 and the content editing function 260. This allows the station programming personnel 60 to access advertising schedule and station spot information anytime, including on-line. The actual content of the ad is also accessed if needed. Access is only given to authorized personnel with security measures in the UIS system based on business logic.

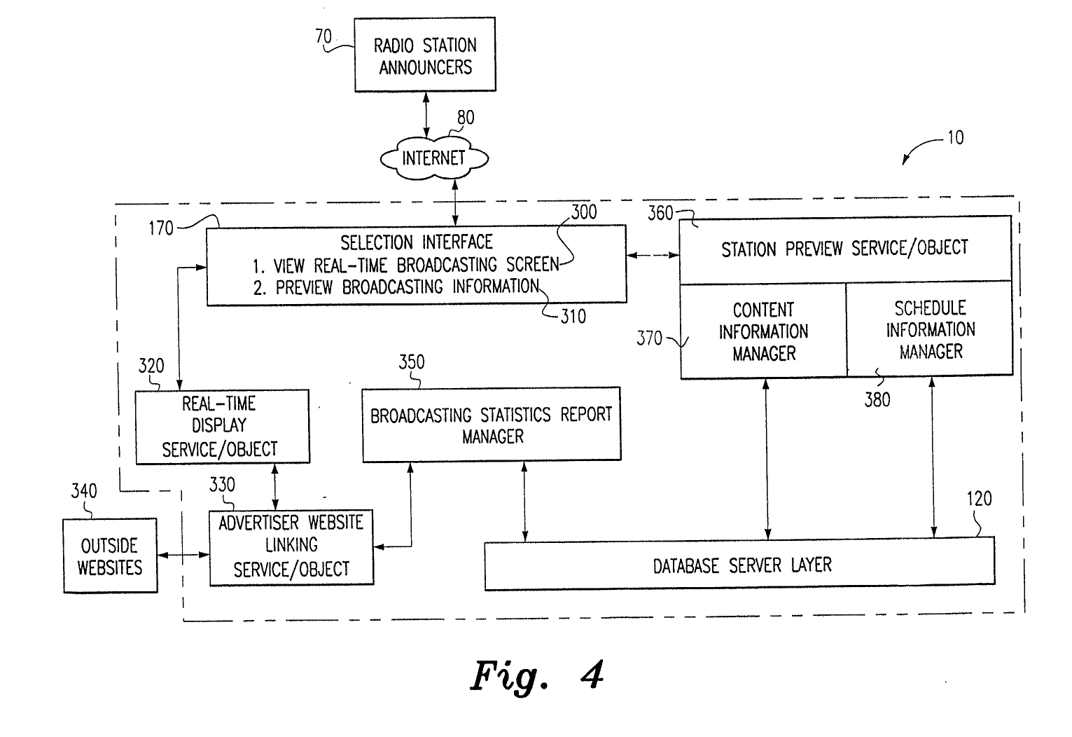

As depicted in FIG. 4, station announcers 70 can also gain access to the Internet 80 and selection interface 170 and choose, for instance, between viewing the real-time broadcasting screen 300 and previewing broadcasting information 310. Assuming a station announcer 70 chooses to view the real-time broadcasting screen 300 and real-time display function 320, he can gain access to the actual content, actual time of the broadcast on a time-driven basis, and interactivity information, such as listener and interaction to particular advertising segment. This information is available for all broadcasts, including news, talk shows, music, commercial advertisement, weather and traffic. The schedule and time on the screen can automatically scroll in a time-based sequence.

An advertiser Web site linking function 330 is also included in the system 10, to allow the station announcer host 70 to broadcast the content of the advertiser's Web site. Such a function is particularly useful when the advertiser is promoting a Web site. When buying the advertisement, the advertiser can enter hyperlinks in the content to allow the station announcer 70 to go directly to designated areas of the Web site through the system 10. As depicted in FIG. 4, the station announcer 70 can broadcast directly from the actual content in an advertiser's Web site 340 to an audience.

To track the actual status of advertised spots, provide instant and accurate feedback to station management and advertisers, a check-go-away (CGA) visual prompt is included for the station announcer 70 to check off the content spot after broadcasting. The prompt will provide time and announcer information to the broadcasting statistics report function 350 for a real-time status report generated by the system 10. This report will be published on-line as soon as its broadcasting is complete, and can be accessed by advertisers and other authorized parties at the UIS system 10.

Assuming that a station announcer 70 at the selection interface 170 chooses to preview broadcasting information 310, through the station preview function 360, if authorized, he can edit the content of the broadcast via the content information function 370. A station announcer 70 can also browse the content and schedule for what is to be broadcast using the schedule information function 380.

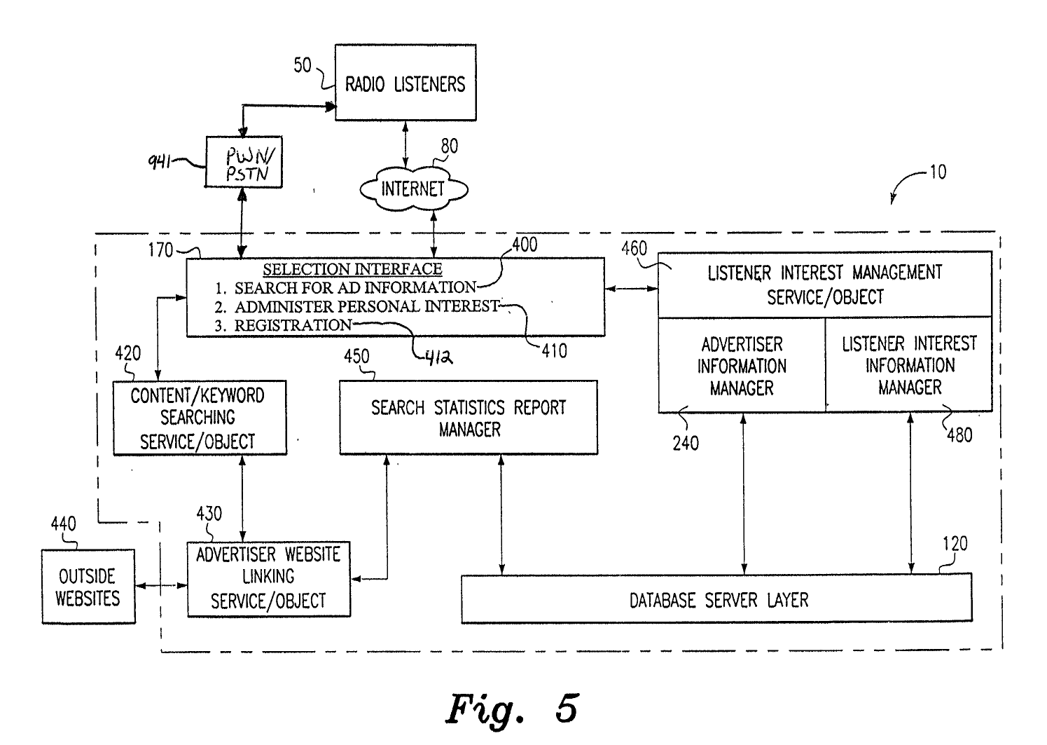

Shown in FIG. 5, listeners 50 can use the Internet 80 to gain access to the selection interface 170 to search for ad information 400 or administer personal interest 410 or provide registration information 412. Assuming a listener 50 chooses to search for ad information 400 through an MSQL 180 interface, he can interact with the content/keyword searching function 420. To search for complete and detailed information, a listener 50 will enter any information retained from the broadcasting into the content/keyword searching function 420. After searching the database server layer 120, the result will be displayed to the listener's 50 screen.

The listeners 50 are also able to log-on UIS 10 via telephone to interact in real time with a broadcasting segment, for example, to find additional information or to give a feedback on a poll per advertiser A-IFI with the touch-tone feature of a telephone, voice recognition and live person assistance without the use of a computer as further described in FIG. 9a.

Some advertisers will prefer to have listeners 50 visit their Web site 440. In AIFI, the advertiser can include advertiser Web site links in function 430, or to include it in the first response message to listener, or direct the listener directly to the Web site. While linking the listener 50 to the outside Web site 440, statistics including information used for searching along with log-on time stamp, hits, on-line trail and listener profile information is generated by the search statistics function 450. This information will be written into the database server layer 120, which will be used for post-broadcasting user service information to advertisers 30, ad agencies 40 and station managers 60.

Assuming listeners 50 choose to administer personal interests 410, the listener can create Consumer Information (instruction) for Interactivity, or C-IFI, to specify that certain type of information be sent to handheld device instantly, for example. Other instruction can be specified by C-IFI such as alternative email address for advertising on home and garden related product and services to be sent to home only; or payment account information (credit card number, etc) and instructions (use card A for all purchases with transaction valued under $10, for example); specific fax number for faxing back specific offers as per A-IFI; when video files in A-IFI, send a link for download instead of the whole file, etc.

The listeners are also given the option and incentive to build a personal profile through M-PURT 160 using the listener interest management function 460. The benefit of the profile information to the listener is to have an agent watch-out for products and services the listener 50 is interested in. The listener 50 can build a personal interest profile with the listener interest information function 480 to determine what to find. The listener interest management function 460 will track the advertisement in the whole network of advertisers against the personal interest profile once a match is found, the listener interest management function 460 will notify the listener 50 via the listeners' 50 choice of e-mail, telephone or text messaging. Listeners 50 can construct a list of relevant advertisers of interest manually with the advertising information function 240 or automatically by the agent in the listener interest information management function 480.

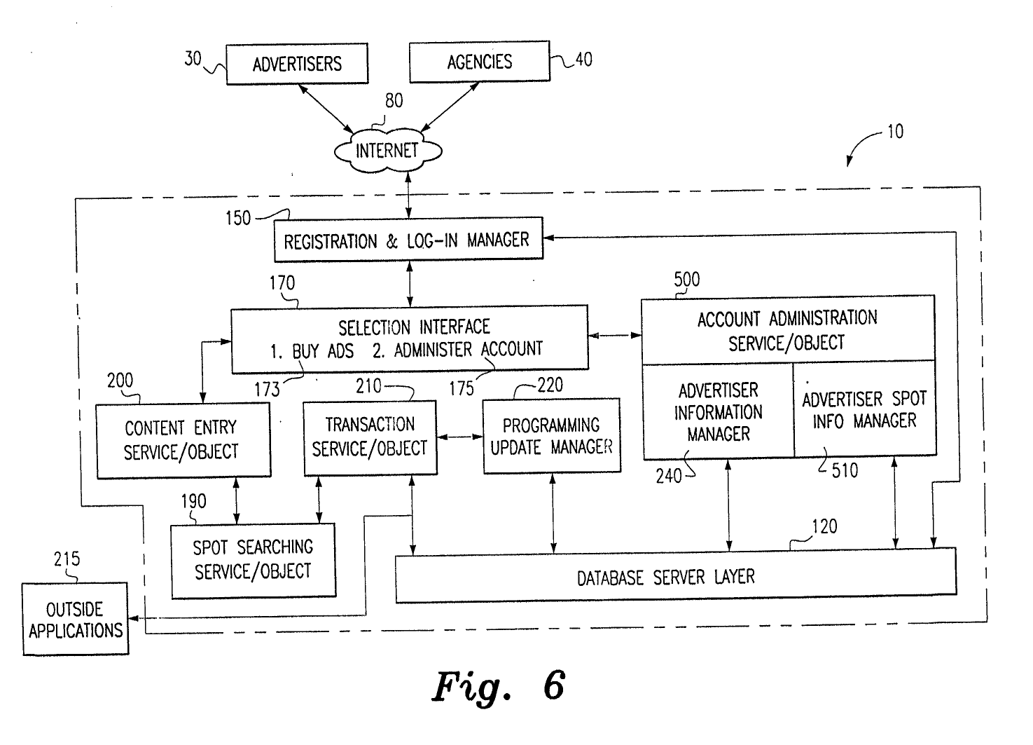

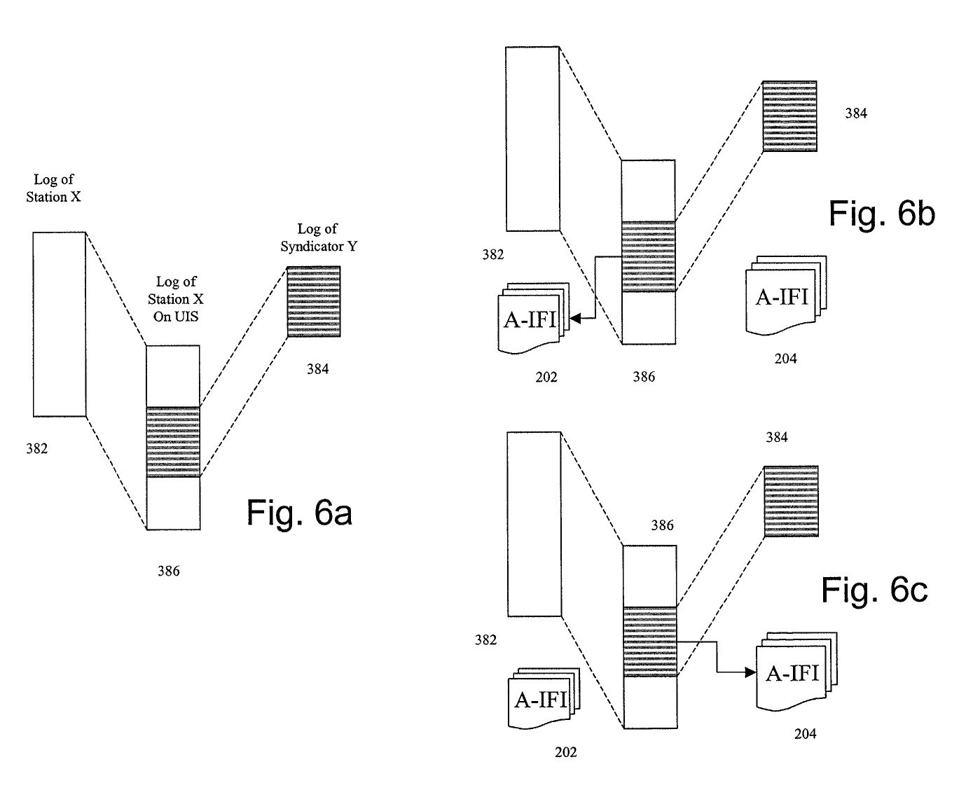

As depicted in FIG. 6, advertisers 30 and agencies 40 can log on the system 10 via the Internet 80. If they are new to the system 10, they will be asked to fill-in the registration page of the multiphase prioritized user registration technique (M-PURT) 160, which is discussed in greater detail in the discussion of FIG. 7. Because of M-PURT 160, registration and log-in 150 will gradually build a user's profile along with the content entry function 200, the spot searching function 190 as well as the transactional function 210. By keeping a core information base and gradually building over time, user retention, satisfaction as well as service will all be enhanced.

At the selection interface 170, the advertisers 30 and agencies 40 have the choice of buying an ad 173 or administering an account 175. Assuming the advertisers 30 and agencies 40 choose to buy ads 173, they can access the content entry function 200 to enter, the actual content of an ad and A-IFI. This A-IFI should include but not limited to coupons generation, distribution, redemption and tracking instructions; offer details, key words for product and services, URLs for web pages, digital audio and video files, questions and answers for interactive sessions, entry instruction for prizes, related information and instruction for faxing back, etc., contact information for interested listeners to respond to the radio ad. Once the content is entered, the system 10 will process the entry, store the content and prepare the information for real time interactive sessions. Although interface function 173 is described as primarily used by advertisers and agencies, there are situations that both broadcast content and A-IFI is entered by other parties into UIS.

Through the meaningful sentence query interface (MSQI), previously discussed in FIG. 3, an advertiser 30 or an agency 40 can access the spot searching function 190 to find airtime spots based on a specific criterion. This should help the advertiser 30 or agency 40 find highly targeted airtime spots quickly and easily. When an advertiser 30 or an agency 40 decides to buy the spots at a particular station, he can simply click a check box besides the spots to buy the respective spots. This is a function of the transaction function 210, which can continue until the advertiser 30 or agency 40 have chosen all of the spots that they want. The advertiser 30 or agency 40 can at anytime, complete the transaction or simply cancel the transaction.

When an advertiser 30 or agency 40 chooses to complete the transaction, the transaction function 210 will display an interface to collect payment information and confirm any user profile changes. As the advertiser 30 or agency 40 inputs payment information, the transaction function 210 will get buyer history information, including payment history from database server layer 120. The transaction function 210 will also link outside applications 215 such as credit bureaus to collect current credit information to further evaluate the advertiser 30 or agency 40.

When all information satisfies the business logic in the system 10, the transaction is completed.

Each successful transaction, including spot buying, content or A-IFI update prompts the system 10 to perform updates through the programming update function 220. The programming update function 220 will publish and send the latest schedule to all stations affected by the completed transaction. The programming update function 220 will also update the database server layer 120 as well.

While some of the functions described in the current invention, such as entering A-IFI, will be performed directly over the internet, other functions, such as advertisement sponsorship, scheduling, ad copy generation will eventually to be done directly over the internet as described. As an interim implementation embodiment, functions will be done “off-line” locally at each station. UIS system 10 will periodically access the computer system of each station, through function 220, to fetch the latest broadcasting log, advertising copy and other related data, then update the information on UIS 10. The information will be processed to match up with advertiser A-IFI entered through 173. UIS 10′ process all the information from radio stations and advertisers to prepare and optimize for interaction. The optimization enables the listener to find the program of interest with the least amount of effort, creating the most effective initial interaction reply to the listener according to A-IFI and continue the interaction in the most appropriate timing, channel and format per C-IFI. To prepare the information, inn the case of a station carrying syndicated broadcast programs, as shown in FIGS. 6a, the log 386 for Station X on UIS 10 is created by combining the log 384 of Syndicator Y (specified be aired at certain time on station log) and log 382 from station X. FIG. 6b shows the matching process for A-IFI, station log and syndicator log is matched based on business logics, such as the station selling advertisement slots vs. syndicator selling sponsorship during the programming time. If the station sells sponsorship, as shown in FIG. 6b, UIS system will match the timing on a particular station log, with the syndicated content and a particular station-sold sponsorship with appropriate A-IFI 202 corresponding to sponsorship. Otherwise, as shown in FIG. 6c, UIS will match the timing on a particular station log, with the syndicated content and a particular syndicator-sold sponsorship with appropriate A-IFI 204 related to sponsorship sold by syndicator. This process ensure the listener to each station can get information on exactly what one hears. Although only one syndicator, one station and one segment shown, applying the principle describe, multiple segments on any syndicators-station combinations can be accomplished by UIS system of the present invention.

Assuming that an advertiser 30 or agency 40 chooses to administer his account 175 at the account administration function 510, he can use the advertiser information function to update any information created before, including profile information and AIFI. An advertiser 30 or agency 40 can also utilize the spot information function 510 to view spots purchased and review the status on broadcast spots. Any new input from the advertiser information function 240 and the advertiser spot information manager 510 will automatically create an update to the database server layer 120.

FIG. 7A and FIG. 7B illustrate the multiphase prioritized user registration technique (M-PURT) 160 used in the registration module in UIS 10′ and its benefit compared to a conventional user registration technique 165, which requires a user to input a substantial amount of information at once. In the M-PURT 160, user information is broken up into groups and given a priority according to certain criterion (For example, business needs).

When users are first visiting the site, first time calling in or buying a cell phone or pager from an affiliated partner, a user is asked to provide information in order to use the interactive service. When convenient, such as user is required to give comprehensive information to sign up for cell phone contract, the registration can be designed to request for information in order to provide interactivity. Under other circumstances, to initiate a relationship in phase 1, the user is first asked to give minimum information of the most importance. This information is typically a phone number and an email address. It can be done over the phone by voice or keypad from most devices. More information is collected a little bit at a time as the user revisits UIS 10′ web site, managing C-IFI or makes additional transactions. The emphasis is on user satisfaction and convenience with the service. Information is collected as the user revisits the site or makes additional transactions, collecting information a little bit at a time instead of all at once. When conscientiously practiced, this paradigm can potentially register more users and gather more user relationship information over time than a more conventional registration technique.

FIG. 8 gives an example of the meaningful sentence query logic (MSQL) 180. The most important feature of the MSQL 180 is that a window 515 on the screen 180 serves as an interface that displays a sentence meaningful to the user as the search criterion is entered. Another important feature is that an interface using MSQL 180 also provides meaning for sentence construction roots, such as “Search for spots” 520 marked by static trunks, such as box 530 and other non-shaded boxes and dynamic branches such as box 540.

The content of these dynamic branches is determined by the selection from the user. For example, when “In a metro area” and “Washington” are chosen by a user, the actual selection will be displayed in window 515. The entry can be typed in as well, especially numerical entries. This technique can be used to construct any interface that requires a multiple search criterion.

In theory, there is no limit to the length of the query. For best results, however, the information should be prioritized and the length should be kept as short as possible for each application. One advantage of using this method is its user friendliness by using human language feedback. Another advantage is the efficiency used to construct a reusable query, which can be saved and retrieved in a complete sentence. The MSQL 180 also allows the system 10 to search faster than a random or poorly constructed query from existing query interface design techniques.

FIG. 9, depicts the use of the UIS system for broadcasting media and response applications as part of a larger system UIS-I 1000. The computer system used with the larger system UIS-I 1000, was called UIS 10′ or WRABAS 10 in previous Provisional Patent Applications.

FIG. 9 outlines an overview where UIS-I 1000 comprises at least one broadcast facility 2100 with broadcast equipment to transmit an electromagnetic signal carrying broadcast, a syndicator broadcasting facility 2100′, the Internet 80, a wireless messaging service provider 940, an electronic media terminal 600 (such as a radio, television, compact disc, digital video disc player or computer), a wearable wireless device 700 (such as a pager or cell phone) and a computer system UIS 10′, that is connected via the Internet 80 with its typical users. Such users include, e.g., a radio announcer 70, a broadcast producer 60, a broadcast scheduler 63, and a syndicator 61. Note that a type A2 listener is a user that is in useful vicinity of an operating electronic media terminal 600, while listener A-1 listener is a user that is driving and is in useful vicinity of an operating electronic media terminal 600.

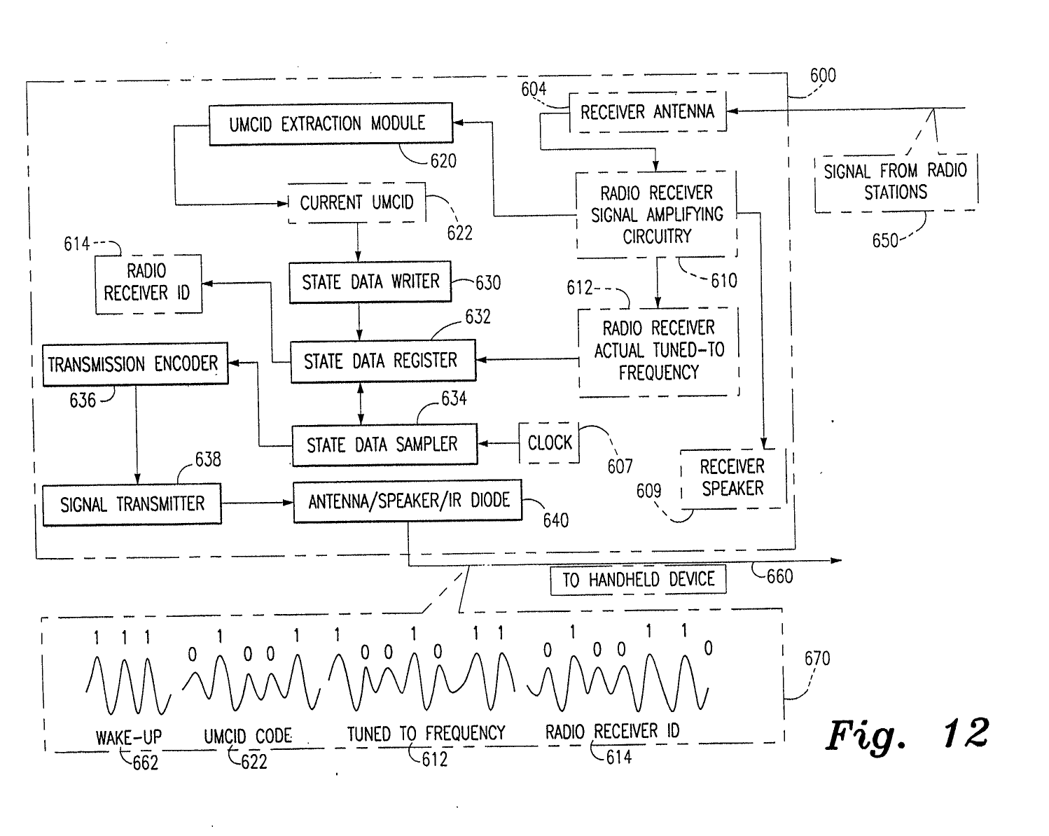

FIG. 9a shows an alternative embodiment to the system of FIG. 9. In this embodiment, the listener 50 presses a pre-programmed button on his wearable wireless device 700, which causes a call to be placed from the device to a call responder 943 via a wireless telephony network and the public switched telephone network PWN/PSTN 941. Once connected, the caller is prompted to enter station identification, i.e., radio station call letters such as WAML, or frequency such as AM630 via natural speech or keypad. In case of frequency entry, UIS 10′ will use ANI or ask for caller's phone calling phone number to determine the exact station requested. The listener will be asked to confirm the station of interest. Then the call responder 81 provides the listener 50 with a short audible list of most likely advertisements based on station information, time of call and past listener behavior pattern. Listener 50 selectively confirm the advertisement of interest by saying, for example, “the Computer ad”. If the interested advertisement is not in the list due to a prolonged delay for calling, the listener is given an option to enter an approximate time the program took place or the name of the advertiser. The system will keep searching until the interested advertisement is found. Or if the caller prefer, a message will be sent to caller with links to desk-top web interface to conduct more advanced search. When the initial interaction succeeded, UIS 10 will retrieve on the consumer user defined C-IFI based on user's ANI (“caller ID”) number or registered phone number, the geographic location that the caller is placing the call from, and/or demographic entries in the listener's user registration profile and advertiser defined A-IFI based advertisement of interest. UISUIS 10′ causes further information about those products or services to be sent, instantly or time delayed, to one or multiple destinations including the user's computer 65 via an internet connection to the WEB 80, and/or send to device 700 via PWN, and/or to a voice or video mailbox 945 with appropriate formats. These information, based on A-IFI, will initiate further interaction. Similar interactions can be accomplished partially or fully through connections via satellite 665, either provide radio broadcast signal or wireless connection for handheld 700. Further details of the interactive process are described below with reference to FIGS. 12-14. UIS

FIG. 9b shows the table lookup process by which a caller will get the information needed to start the interaction. When a call reaches the call responder 943, ANI or phone number entered by the caller will prompt UIS 10′ to limit the search for station if station frequency is entered. By presenting stations of similar frequency from different geographically areas, caller can confirm the exact station designated by station call letters. Each station is identified by a station ID in UIS 10′. Also referring to FIGS. 6a&b, based on the time of call, call responder will dynamically present a list of keywords from advertisements on a listened-to station log on UIS 10′ right before the time of call. When caller confirms the advertisement, a unique target ID will point to an advertisement serial number representing one advertisement copy. If desired by the advertiser, a set of A-IFI can be attached to each copy to start a specific interaction. The A-IFI can be dynamically modified or combined with C-IFI to initiate the most optimized interaction by both advertiser and listener.

FIG. 10 depicts the use of the electronic media terminal 600 and the wearable wireless device 700. The electronic media terminal 600 can represent any radio receiver, television, computer, compact disc or MPEG 3 receiver on which an electronic media session can be conducted with one or a plurality of users. The electronic media terminal 600 utilizes a radio receiver with a dial 602, antenna 604, display 606 and speaker 608. An electromagnetic signal-carrying analog or digital signal 650 is produced from the broadcast facility's tower 645 or satellite 665.

An alternative embodiment to that shown in FIG. 10 utilized the tune-to frequency of the radio receiver. Such information can be derived using the differential of local oscillating frequency and the frequency emitted from the unit. The modifications required of the device 700 from today's common handheld device is to add circuitry to filter the noise while monitoring the presence of peak energy frequency in commercial radio bands. Then feed this data to the automatic messaging module in 700 described in FIGS. 10-14. The advantage of such embodiment is that it only requires modification to the handset. However, the accuracy is time and location information dependent. When equipped with a series of electronics incorporating the techniques of the present invention to extract information from the radio signal, a new and different signal 660 is generated and transmitted. The signal 660 contains all of the information in packet 670 (FIG. 12) in media that is imperceptible to humans. 642 represents one or more energy transducers that send the new signal 660 to the wearable wireless device 700, and converts electromagnetic energy from the broadcast signal 650 into another form of signal such as Bluetooth, HomeRF, Infrared, sub-audible or ultrasound.

The wearable wireless device 700 can be one of any type of two-way pager, cell phone, laptop computer or other device capable of sending a wireless e-mail message. The wearable wireless device 700 includes a message display 706, an antenna 704 and a transducer 720 for receiving signals from the transducer 642 of the electronic media terminal 600. There are also activation buttons 710, 712 and 714 located on the wearable wireless device 700 that allow a user to conveniently press any button to initiate and send a message, such as requesting more information or to express selections in the options given in a media session or opinion poll without looking at the device.

The wearable wireless device 700 is designed to automatically collect media session information and to generate a message to UISUIS 10′, while being completely transparent to the user. All the user needs to do is to press the appropriate button(s) and a comprehensive and intelligent interaction request is made to UIS system in a single step. UIS10′ provides an automatic interaction reply 832 to a user, and a response report of an automatic poll tally report 822, for example, to a station.

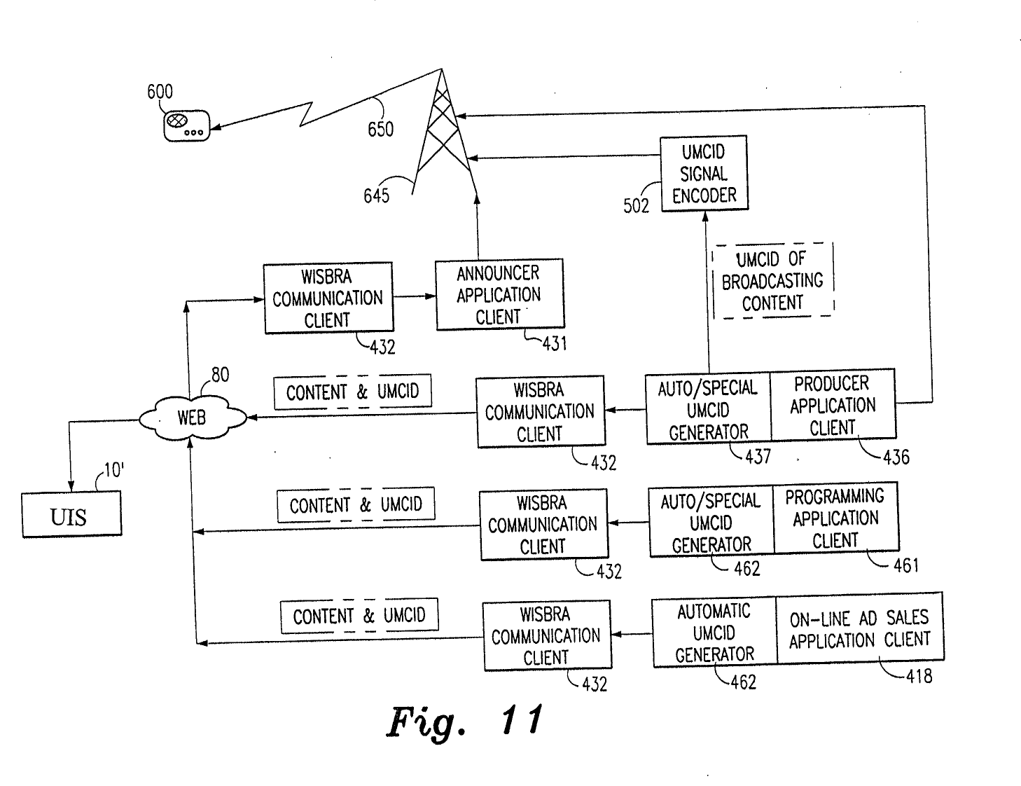

Referring to FIG. 9 and FIG. 11, broadcast scheduler 60 and on-line advertisement buyers 30 will input broadcast content, A-IFI and programming time spot information into UIS 10′. The content can be advertisement script, recordings or other materials. When an advertisement session is entered through 418, the Unified Media Content Identification (UMCID) generator 462 will assign a unique code and attaches the code to advertisement content before uploading the entry through Web communication client 432 to UIS 10′.

A typical UMCID 462 contains at least 4 segments of information to identify (1) the content originator, for example, an advertisement buyer, a news reporter, a meteorologist, song singer or a band; (2) the agency representing the ad buyer if any; (3) the broadcasting network affiliation or syndicator; and (4) the station from which the audience actually receives the broadcast. Each segment is further divided into sections and a vocabulary is established on UIS 10′ and UMCID generating system in broadcast facilities 2100 and 2100′. The vocabulary, representing individuals, organizations, actions, instructions and other information, will enable UMCID generation during broadcast and retrieval at UIS 10′ to efficiently facilitation interactivity.

UMCID 462 enables all electronic media terminals 600 to transmit information in an identical format so that any wearable wireless device 700 in the vicinity can accurately receive, recognize and understand the content identification information. The significance of this is that it enables users with a wearable wireless device 700 to interact with a media session easily and conveniently, anywhere, anytime and to any media presented through the electronic media terminal 600.

When a producer 60 directs the actual broadcast session partially from the content in existence in UIS 10′. If a prerecorded advertisement is played, that recording will carry the first two segments of UMCID 462, advertiser and agency. If a song is played, producer application client 436 will, (through a hardwired or wireless connection), give a command to activate the broadcast equipment 645 to transmit the signal carrying the song. The song carries the first two segments of UMCID 462, song singer and agent/publisher. If the advertisement is to be read by the radio station announcer 70, the auto/special UMCID generator 437 in producer application client 436 will generate a UMCID 462 consisting of all four sections with first two segments occupies, third segment blank and last segment carrying station information.

When a poll question is aired by a radio station, the broadcast producer 60 will manually assign an additional section representing “polling” in the station segments of the UMCID 462 through the auto/special UMCID generator 437. If a poll is conducted by a network, the network will assign an additional section representing “polling” in the third segments of the UMCID 462 through the auto/special UMCID generator 437. Similarly, when an auction is aired, the producer will manually assign a section in the appropriate segments representing “auction” in UMCID vocabulary through the auto/special UMCID generator 437. The automatic UMCID generator 462 and auto/special UMCID generator 437 will add the last two sections representing network affiliation and station identification.

Each time a program is broadcast, the UMCID information is automatically sent to the UMCID signal encoder 502 to be prepared for transmission with the broadcast signal 650. One embodiment fort the UMCID 462 to function is to add it in recordings as a beacon. As a result, the UMCID 462 will be present at the beginning of the song recording and then will come up, for example, every 20 seconds. In addition, the UMCID's codes 622 can be designed to be data-economical and therefore the UMCID 462 requires very little bandwidth. If the UMCID is to be transmitted from 600 to 700 using acoustic signals, it can be coded to use one or multiple frequencies as an acoustic modem.

FIG. 12 shows how a broadcast signal 650 is processed by the present invention to generate identification signal 660. Through antenna 641, signal 650 is processed by a radio receiver signal amplifying circuitry 610 to produce audio signal for speaker 609. The pass through or preprocessed signal from 650 is then sent to UMCID extraction module 620 for current UMCID 622 of the content in broadcasting, which is then sent to state data writer 630 to input into state data register 632. Although described as separate entities, transducers for UMCID can be the same unit as speaker 609, for example, to when appropriate.

Data register 632 is a data holding center, responsible to keep the UMCID radio receiver actually tuned-to frequency 612, which is available from the amplification circuitry 610, and radio receiver identification number 614, which is stored in the receiver by the manufacturer. Register 632 is capable of keeping as much state change history as practical, for example last ten programming segments, since the primary function of register 632 is to keep UMCID history.

There are several factors that can cause state data sampler 634 to fetch data from register 632 and thereby initiate a data transmission 660. When data register 632 has a state change, either as a result of an UMCID update or if the listener changes the radio station (resulting in new frequency data), it will send a message to data sampler 634 to fetch data from register 632.

When there is no change to the state data register 632, a clock 607 will periodically prompt data sampler 634 to fetch data from the state data register 632. Each time the data is obtained by the data sampler 634, it is forwarded to transmission encoder 636 to assemble into a desired format. The data is then sent to the signal transmitter 638 and then to antenna/speaker/IR diode 640, where it is then transmitted into signal 660.

One format of transmission used in the preferred embodiment is depicted by sample 670. The sample packet includes a wakeup segment 662, a segment for UMCID code 612, a segment for tuned to frequency 612 and a radio receiver ID segment 614. Although the illustration is using amplitude modulation, there are other methods such as RF frequency modulation, acoustic and infrared are considered as a format of transmission to achieve the objectives of the present invention.

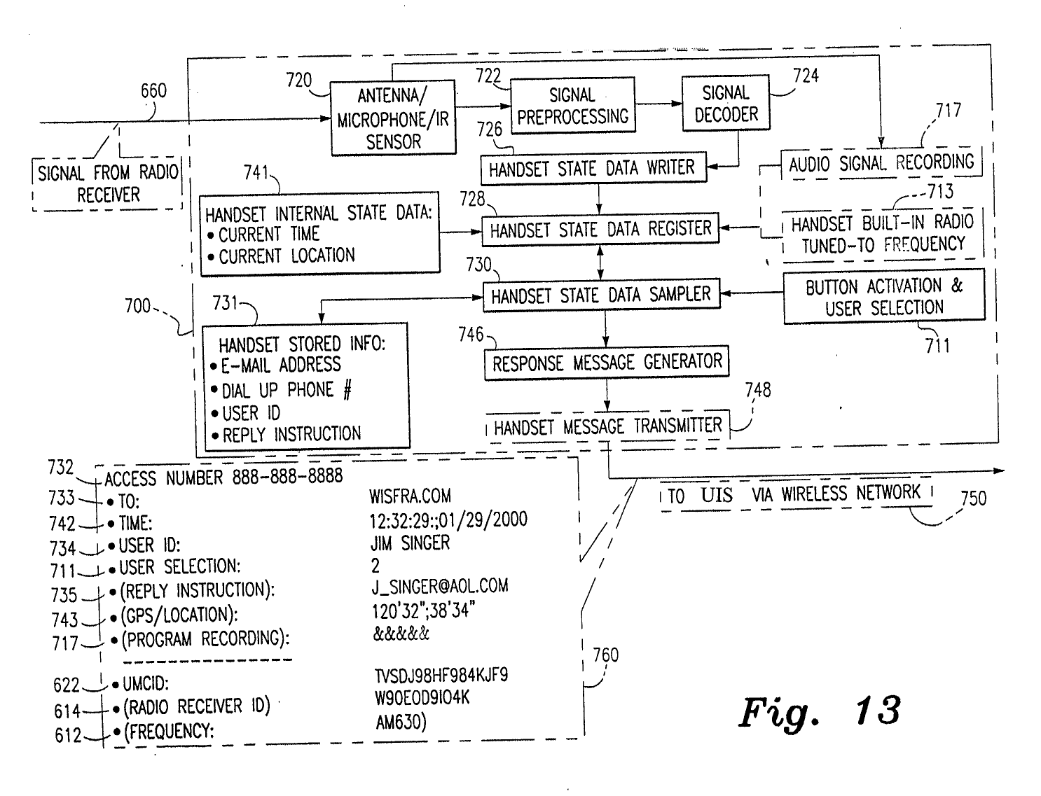

In FIG. 13, when signal 660 from electronic media terminal 600 is detected by the antenna/microphone/IR sensor 720 of wearable wireless device 700, the signal 660 is then fed into a signal preprocessing module 722 for correction and amplification. The output from the pre-processing module 722 is sent to decoder 724 to be written to the handset state register 728 by the handset state writer 726. Handset state register 728 takes input, that includes current time and handset location information, from the handset's internal state memory 741, audio signal 717 as well as the handset's built-in radio receiver tuned to frequency detector data 713. The handset state data register 728 also holds the history of state changes from all input sources. In the case that TV or radio receiver 600 is integrated as part of device 700, many of the separate functions described above can be combined or simplified with out departing from the scope of the present invention.

When an input from the button activation and user selection 711 is made, the handset state data sampler 730 requests a data transfer from 728 and handset stored information, which is provided by the user and updateable remotely via radio transmission from the central office of a wireless network service provider 940. Data sampled by the handset state data sampler 730 is then compiled into an email in response to message generator 746. Through the handset's own message transmitter 748, message 760 is transmitted via wireless network service provider 940 to UIS 10′.

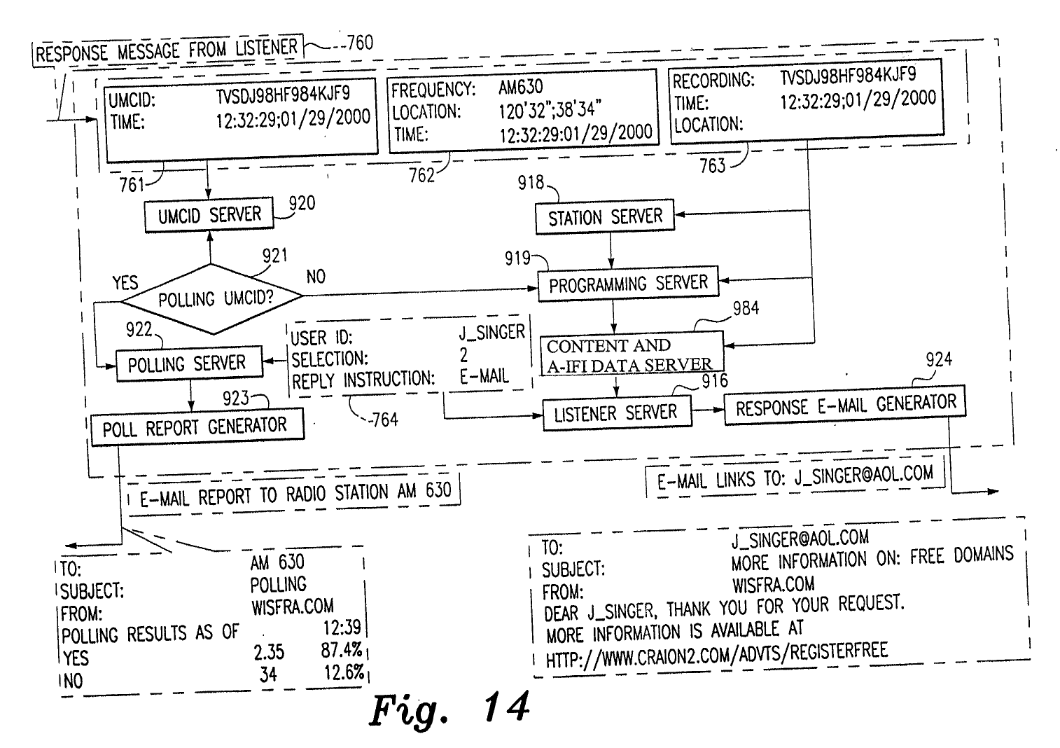

As depicted in FIG. 14, the received message 760 is reassembled into four parts, UMCID and time 761; frequency, location and time 762; recording, time and location 763 and user ID, selection and reply instructions 764 specified in C-IFI. Redundant information from UMCID, frequency and recording is intentionally included here to illustrate when only some information is present, how the response is processed by UIS 10′. Such information redundancy is typically desired for better quality of response message and versatility for processing. It is possible, however, that the limitation of bandwidth may initially limit the actual use of some information, such as recording or other data described in 760.

If all of the information is present, message 761 will be given first priority for processing in UMCID server 920, as it is data efficient and containing all information to determine the audience's interest. UMCID server 920 will retrieve all of the information related to UMCID part 761 and create a data pack to pass on to logic module 921 to decide where the data pack will be forwarded.

There are typically four types of processing outcomes to a response to start the interaction. UIS 10′ will determine and optimize the outcome most appropriately according to time, A-IFI, C-IFI, bandwidth requirement, urgency of request, location of request and user behavior patterns. One is to provide a reply message including links and information relative to the response message so the listener can interact at a later time. A second type of processing outcome is to use the response and interaction data to generate a report and e-mail back to the media company (as shown in FIG. 14) depicted as “polling”, which can be bidding, voting, product sample request or movie ratings or other high interactivity applications. It should not be construed that the examples above are to limit the scope of disclosed invention. A third type of processing outcome is to use the response data to select and send to the listener an electronic copy of a musical selection or other content that the listener 50 desires to receive. In this respect, the system of the invention can be used to allow a listener 50 who is listening to a musical selection to receive an electronic copy (e.g., an MP3 file) of that musical selection simply by pressing the pre-programmed button on his wearable wireless device 700. A fourth type is for UIS 10′ to automatically initiate a phone call to listener's registered phone number instantly to allow the listener to interact immediately with UIS 10′ or bridging the call directly to the advertiser. The outcome of the processing is optimized to simultaneously address the needs of advertiser and the listener as expressed in A-IFI and C-IFI.

As described earlier, if an UMCID indicates a “polling” response, the information output from the UMCID server 920 will be sent to polling server 922, where the user ID/selection/reply information 764 is combined before sending to poll report generator 923. An example of a polling result report 832 is e-mailed to the polling station (for example, AM 630) at a specific cut off time. Similarly, if the message from the audience is in response to a media session requesting bidding, voting or rating from the audience, poll server 922 and poll report generator 923 will be respective bidding, voting or rating poll servers 922 and report generators 923. The same polling result can also be emailed to participants.

Services such as Polling can also be processed when a response only contains frequency, location and time 762 is available to station server 918 and programming server 919. To determine the station and program to which the audience responded, if a program is found UIS 10′ to be one that requested an audience's opinions and aired time matches the audience response time, all resulting information from processing in servers 918 and 919 is sent to polling server 922, wherein a report is generated and e-mailed as previously described.

If the UMCID indicates an information request by the audience, output from UMCID 920 or combined output from station server 918, programming server 919 and content & A-IFI data server 984, will be read by listener server 916 along with user ID, selection and reply instruction 764 for processing. Including the pertinent link and other A-IFI addressing the audience request, response e-mail generator 924 will then compile one or multiple messages 822, which will be sent to one or more destinations following reply instructions in the C-IFI from the particular requester.

The commercial implications of the Universal Interactive Service are broad. The interactions facilitated by the UIS system brings significant financial and time benefit to listeners, advertisers and broadcasters. For example, currently, radio commercial advertising, in order for it to be effective, must be repeated many times before a listeners can be remember the ad and the phone number to call. More over, the advertiser typically has to follow up with massive direct mails to get the detailed information to listeners. This takes more time and money. The listener is experiencing frustration for wanting to get certain information but physically unable to write it down or remember it.

With the Universal Interactive Service, the station can program the broadcast so that it has “depth”. For a car dealer to advertise on radio, in the A-IFI, the dealer can put in coupons and reminders. When a listener request to interact with the advertisement, as part of the initial reply, a coupon may be included to get a new set of tire for half price before Sunday. Such coupon can partially or totally replaces the direct mail needed before. The listener will be asked to opt-in for a reminder. On Saturday, on either the device 700 or computer 65, a reminder is sent to the listener, encouraging him to go to the dealer before Sunday. As added incentive, if he goes to the dealer before Sunday, he can get 1 year of oil change for free if he purchases a vehicle. Also, he is provided with information how to go to the website for pre-selection before go to the dealer and about the best way to get to the dealer. Submitting pertinent information online, when the listener arrives, all the credit was approved and paper work ready. The listener has most information on perspective vehicle. With very little effort and two incentives, the listener soon happily drive away in the new car. As part of the optimization function of UIS 10′, the UIS 10′ constantly measures and applies overall effectiveness to improve services for listeners, broadcasters and advertisers.

There are at least five practical ways outlined by the present invention to facilitate communication between electronic media terminals 600 and wearable wireless devices 700. One preferred way of communicating information is to include a UMCID signal in the broadcast. This can be in the form of an acoustic signal, preferably ultrasound, sub-audible, or other electromagnetic signal which sends a UMCID simultaneously with the regular audio, text or video signal. The wearable wireless device 700 is equipped to recognize, capture and translate the signal into a useful data piece. This method is actively relaying the information to the vicinity. Therefore, it is possible to implement the information into all forms of electronic media terminals.

Using local oscillating frequency from a listener's 50 radio set, it is known that when a particular station is tuned to a radio set 50, the radio emits an electromagnetic signal at a particular frequency. Such a frequency can be correlated to the broadcasting frequency of a tuned-to station based on local oscillating frequency of the receiver. Using this principle, a wearable wireless device 700 is equipped with a RF receiver that registers the emitting frequency from an active radio receiver. The registered frequency generates a piece of data that dynamically changes as the listener 50 changes radio stations or gets close to an another operating radio receiver. The data will be included in the message sent to UIS 10′ and is compared with the frequencies of stations in a geographical area.

A third way of capturing information for radio station identification is to modify radio sets 50 to produce a non-intrusive signal reflecting the radio units actual tuned-to frequency, which is readily available for displaying channels or stations to users.

A fourth way of capturing information for radio station identification is to record the actual audio signal from the radio unit of the radio station's actual broadcast. A fifth way is to use a combination of two or more methods previously described to yield the most accurate result.

Although the wireless device described herein as a proffered embodiment, it is conceivable that hardwired devices when incorporated technology and the principles described in the present invention, through telecommunication networks, can satisfy the functional needs thus present a viable alternative.

It is clear that such a service will a utility to broadcast media. The financial arrangement of the service reflects the overall need and satisfaction of that need. Logical arrangement will be charging per potential or active interactive user. For example, charging a radio station $0.1 per year per radio listener. This will ensure the radio station can provide all advertisement of all advertiser s interactive service.

While the invention has been particularly shown and described with reference to a preferred embodiment thereof, it will be understood by those skilled in the art that various changes in form and details may be made therein without departing from the spirit and scope of the invention.

The embodiments of the invention in which an exclusive property or privilege is claimed are defined as follows:

1. A universal interactive service implementation system for allowing consumers to interact with electronic media to find specific information, express opinions or ask a question, and for allowing electronic media and sponsors of broadcasting to get more information about listeners that are exposed to their advertising, and for facilitating the purchasing and selection of advertising by advertising buyers, comprising:
means for interacting with a consumer to receive and store consumer registration information including consumer-generated instructions for interactivity between said consumer and the system;
an interface to a telecommunication device that is used by said consumer;
means for entering, storing, processing and optimizing data from multiple media facilities and content generators for universal interactive services;
a universal interactivity service for facilitating interaction between a media and/or content generator and said consumer via said interface in accordance with said consumer-generated instructions and/or other instructions from media and content generator, said universal interactivity service being capable of receiving information from said telecommunication device sufficient to identify a program that said consumer was viewing or listening to at a time when a pre-programmed button on said wireless handheld device was actuated; and,
means for storing data generated during said interaction with said consumer and for reporting statistical information derived from said data.

2. The universal interactive service implementation system in accordance with claim 1, wherein said universal interactivity service comprises a voice responder.

3. The universal interactive service implementation system in accordance with claim 1, wherein said universal interactivity service uses radio frequency detection means in said consumer's telecommunication device to determine a station and/or the program that said consumer was viewing or listening to at a time when a pre-programmed button on said telecommunication device was actuated.

4. The universal interactive service implementation system in accordance with claim 1, wherein said universal interactivity service uses acoustic detection means in said consumer's telecommunication device to determine a station and/or the program that said consumer was viewing or listening to at a time when a pre-programmed button on said telecommunication device was actuated.

5. The universal interactive service implementation system in accordance with claim 1, wherein said universal interactivity service uses said consumer's ANI to determine a station that said consumer was viewing or listening to at a time when a preprogrammed button on said telecommunication device was actuated.

6. The universal interactive service implementation system in accordance with claim 1, wherein said universal interactivity service uses said consumer's location information to determine a station that said consumer was viewing or listening to at a time when a pre-programmed button on said telecommunication device was actuated.

7. The universal interactive service implementation system in accordance with claim 1, wherein said universal interactivity service uses user input from a keypad on said consumer's telecommunication device to determine station that said consumer was viewing or listening to at a time when a pre-programmed button on said telecommunication device was actuated.

8. The universal interactive service implementation system in accordance with claim 1, wherein said universal interactivity service uses a voice response received from said consumer's communication device to determine station that said consumer was viewing or listening to at a time when a pre-programmed button on said communication device was actuated.

9. The universal interactive service implementation system in accordance with claim 2, wherein said universal interactivity service generates a short audible list of most likely content and receives from said consumer a selection of one of said content.

10. The universal interactive service implementation system in accordance with claim 1, further comprising:
means for selecting digital content in response to said interaction with said consumer and for transmitting said digital content to said consumer.

11. The universal interactive service implementation system in accordance with claim 8, wherein said digital content comprises further information related to said program that said consumer was viewing or listening to at a time when a pre-programmed button on said telecommunication device was actuated.

12. The universal interactive service implementation system in accordance with claim 8, wherein said digital content comprises an audio or video file.

13. The universal interactive service implementation system in accordance with claim 1, wherein said consumer is a radio listener and said program is a radio program.

14. The universal interactive service implementation system in accordance with claim 1, wherein said consumer is a television viewer and said program is a television program.
